(19) United States
(12) Patent Application Publication
(10) Pub. No.: US 2025/0303782 A1
(43) Pub. Date: Oct. 2, 2025

(54) Heat-Transfer Board Customization Device

(71) Applicant: Alexander Hernandez, Orange Grove, TX (US)

(72) Inventor: Alexander Hernandez, Orange Grove, TX (US)

(21) Appl. No.: 18/824,983

(22) Filed: Sep. 5, 2024

Related U.S. Application Data
(60) Provisional application No. 63/571,034, filed on Mar. 28, 2024.

(51) Int. Cl. B44C 1/17; B44D 3/22

(52) U.S. Cl. CPC B44C 1/172; B44D 3/22

(57) ABSTRACT

A heat-transfer board customization device is provided. The device is designed to enable users to apply custom designs to sports boards such as skateboards, snowboards, surfboards, and similar boards. The device comprises a board, a heat transfer sheet, and a drawing utensil. The transfer sheet can be applied to the board and heated to transfer a design onto the board's surface. The sheet may be pre-printed with a design, have an outlined design for users to further customize, or may be blank for custom drawing. Drawing utensils, including paint pens or markers, are compatible with the transfer sheets, allowing further customization. The invention also includes several methods for using the device, involving steps of designing on the transfer sheet, applying heat to the sheet after placing the sheet on the board, and transferring the design onto the board.

### CROSS-REFERENCE TO RELATED APPLICATION

The present application claims priority to, and the benefit of, U.S. Provisional Application No. 63/571,034, which was filed on Mar. 28, 2024, and is incorporated herein by reference in its entirety.

### FIELD OF THE INVENTION

The present invention relates generally to the field of design transferring devices and methods. More specifically, the present invention relates to a heat-transfer board customization device that allows users to apply a customizable design to a sporting board via heat-transfer. Accordingly, the present disclosure makes specific reference thereto. Nonetheless, it is to be appreciated that aspects of the present invention are also equally applicable to other like applications, devices, and methods of manufacture.

### BACKGROUND

Skateboards, snowboards, and surfboards each have a surface that can be uniquely decorated and personalized by their owners. This customization is a key feature that allows individuals to express their personal style and preferences through the design of their board. These products are typically made to order with specific custom artwork or designs chosen by the customer. This bespoke approach ensures that each board is unique and tailored to the buyer's tastes. However, once the board is created with its custom artwork, it cannot be modified or adjusted later. If a person is unable to customize their board according to their liking during the initial order process, they may feel dissatisfied or disappointed with the final appearance of the product, which may not fully align with their aesthetic desires or expectations. The inability to personalize their board could detract from their overall experience and enjoyment, highlighting the importance of customization options in these types of products.

Therefore, there exists a long-felt need in the art for a device that allows a user to customize a board. There also exists a long-felt need in the art for a heat-transfer board customization device that allows a user to customize the appearance of a sporting equipment board. More specifically, there exists a long-felt need in the art for a heat-transfer board customization device that allows a user to customize the appearance of a sporting equipment board via drawing and/or coloring a custom design. Further, there exists a long-felt need in the art for a heat-transfer board customization device that allows a user to customize the appearance of a sporting equipment board via drawing and/or coloring a custom design, wherein the design can be applied to whichever area of the board a user chooses.

The subject matter disclosed and claimed herein, in one embodiment thereof, comprises a heat-transfer board customization device. The device is designed to enable users to apply custom designs to sports boards such as skateboards, snowboards, surfboards, and similar boards. The device comprises a board, a heat transfer sheet, and a drawing utensil. The transfer sheet can be applied to the board and heated to transfer a design onto the board's surface. The sheet may be pre-printed with a design, have an outlined design for users to further customize, or may be blank for custom drawing. Drawing utensils, including paint pens or markers, are compatible with the transfer sheets, allowing further customization. The invention also includes several methods for using the device, involving steps of designing on the transfer sheet, applying heat to the sheet after placing the sheet on the board and transferring the design onto the board.

In this manner, the heat-transfer board customization device of the present invention accomplishes all the forgoing objectives and provides a device that allows a user to customize the appearance of a sporting equipment board. More specifically, the device allows a user to customize the appearance of a sporting equipment board via drawing and/or coloring a custom design. Then, the design can be applied to whichever area of the board a user chooses via heat transfer.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a heat-transfer board customization device. The device may be comprised of a board, at least one transfer sheet, and at least one drawing utensil. The device allows a user to place a custom design on a board using the transfer sheet, wherein the design may be further customized via the drawing utensil. The board may be any style of sports board known in the art, which includes but is not limited to a skateboard, a snowboard, a surfboard, a paddleboard, a wakeboard, etc.

The transfer sheet can then be applied to the board (wherein the sheet may be applied to any surface and/or area of the board) such that the design remains on the board when the transfer sheet is removed. More specifically, the transfer sheet is preferably a heat transfer sheet, wherein the sheet can be placed on the board, heated such that the design is transferred onto the board, and then removed.

The sheet may have at least one design. The design may be any color and may be any indicia such as but not limited to a shape, a letter, a number, a picture, a scene, a logo, a symbol, etc. In one embodiment, an outline of the design is imprinted onto the sheet during the manufacturing process, wherein the remainder of the design can be colored as desired by a user via at least one drawing utensil. In a different embodiment, the sheet has no design imprinted during the manufacturing process, wherein a design can be drawn on (and colored) by the user using the drawing utensil prior to heat transfer. In a further embodiment, the design may be fully imprinted and colored during manufacturing. These different embodiments allow a user to exercise various degrees of customization over the design and/or color/appearance of the design. The drawing utensil may be any type of drawing utensil that is compatible with the transfer sheet.

The present invention is also comprised of a method of using the device. First, a device is provided comprised of a board, a transfer sheet, and a drawing utensil. Then, a user can either draw at least one design on the transfer sheet, coloring an existing design on the transfer sheet via the drawing utensil or leave an existing design on the transfer sheet untouched. Next, a user can place the transfer sheet onto a surface of a board and apply heat to the transfer sheet for a period of time greater than at least 5 seconds. Finally, a user can remove the transfer sheet from the board, wherein the design is transferred onto a surface of the board.

Accordingly, the heat-transfer board customization device of the present invention is particularly advantageous as it provides a device that allows a user to customize the appearance of a sporting equipment board. More specifically, the device allows a user to customize the appearance of a sporting equipment board via drawing and/or coloring a custom design. Then, the design can be applied to whichever area of the board a user chooses via heat transfer. In this manner, the heat-transfer board customization device overcomes the limitations of existing methods of decorating sporting boards known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a heat-transfer board customization device of the present invention in accordance with the disclosed architecture;

FIG. 2 illustrates a flowchart of a method of using one potential embodiment of a heat-transfer board customization device of the present invention in accordance with the disclosed architecture;

FIG. 3 illustrates a flowchart of a method of using one potential embodiment of a heat-transfer board customization device of the present invention in accordance with the disclosed architecture; and

FIG. 4 illustrates a flowchart of a method of using one potential embodiment of a heat-transfer board customization device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to customize a board. There also exists a long-felt need in the art for a heat-transfer board customization device that allows a user to customize the appearance of a sporting equipment board. More specifically, there exists a long-felt need in the art for a heat-transfer board customization device that allows a user to customize the appearance of a sporting equipment board via drawing and/or coloring a custom design. Further, there exists a long-felt need in the art for a heat-transfer board customization device that allows a user to customize the appearance of a sporting equipment board via drawing and/or coloring a custom design, wherein the design can be applied to whichever area of the board a user chooses.

The present invention, in one exemplary embodiment, is comprised of a heat-transfer board customization device. The device may be comprised of a board, at least one transfer sheet, and at least one drawing utensil, wherein the device allows a user to place a custom design on a board using the transfer sheet. In one embodiment, the design may be further customized via the drawing utensil. The board may be any style of sports board known in the art, which includes but is not limited to a skateboard, a snowboard, a surfboard, a paddleboard, a wakeboard, etc.

The transfer sheet can then be applied to the board (wherein the sheet may be applied to any surface and/or area of the board) such that the design remains on the board when the transfer sheet is removed. More specifically, the transfer sheet is preferably a heat transfer sheet. Then, the sheet can be placed on the board, heated such that the design is transferred onto the board, and then removed.

The sheet may have at least one design that may be any color and may be any indicia such as but not limited to a shape, a letter, a number, a picture, a scene, a logo, a symbol, etc. In one embodiment, an outline of the design is imprinted onto the sheet during the manufacturing process, wherein the remainder of the design can be colored as desired by a user via at least one drawing utensil. In a different embodiment, the sheet has no design imprinted during the manufacturing process, wherein a design can be drawn on (and colored) by the user using the drawing utensil prior to heat transfer. In a further embodiment, the design may be fully imprinted and colored during manufacturing. These different embodiments allow a user to exercise various degrees of customization over the design and/or color/appearance of the design. The drawing utensil may be any type of drawing utensil that is compatible with the transfer sheet.

The present invention is also comprised of a method of using the device. First, a device is provided comprised of a board, a transfer sheet, and a drawing utensil. Then, a user can either draw at least one design on the transfer sheet, coloring an existing design on the transfer sheet via the drawing utensil or leave an existing design on the transfer sheet untouched. Next, a user can place the transfer sheet onto a surface of a board and apply heat to the transfer sheet for a period of time greater than at least 5 seconds. Finally, a user can remove the transfer sheet from the board, wherein the design is transferred onto a surface of the board.

Accordingly, the heat-transfer board customization device of the present invention is particularly advantageous as it provides a device that allows a user to customize the appearance of a sporting equipment board. More specifically, the device allows a user to customize the appearance of a sporting equipment board via drawing and/or coloring a custom design. Then, the design can be applied to whichever area of the board a user chooses via heat transfer. In this manner, the heat-transfer board customization device overcomes the limitations of existing methods of decorating sporting boards known in the art.

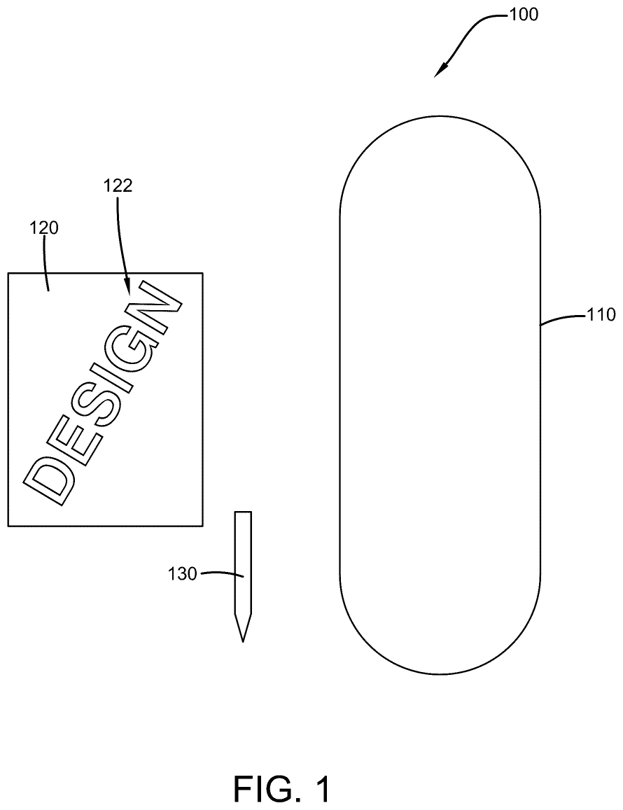

Referring initially to the drawings, FIG. 1 illustrates a perspective view of one potential embodiment of a heat-transfer board customization device 100 of the present invention in accordance with the disclosed architecture. The device 100 may be comprised of a board 110, at least one transfer sheet 120, and at least one drawing utensil 130. The device 100 allows a user to place a custom design 122 on a board 110 using the transfer sheet 120, wherein the design 122 may be further customized via the drawing utensil 130.

The board 110 may be any style of sport board known in the art, which includes but is not limited to a skateboard, a snowboard, a surfboard, a paddleboard, a wakeboard, etc. The transfer sheet 120 can then be applied to the board 110 (wherein the sheet 120 may be applied to any surface and/or area of the board 110) such that the design 122 remains on the board 110 when the transfer sheet 120 is removed.

More specifically, the transfer sheet 120 is preferably a heat transfer sheet, wherein the sheet 120 can be placed on the board 110, heated such that the design 122 is transferred onto the board 110, and then removed. The sheet 120 may be made from any heat transfer sheet material. This includes but is not limited to a heat transfer vinyl, a polyurethane transfer paper, a sublimation transfer paper, a hot-peel transfer paper, etc.

The sheet 120 may have at least one design 122. The design may be any color and may be any indicia such as but not limited to a shape, a letter, a number, a picture, a scene, a logo, a symbol, etc. In one embodiment, an outline of the design 122 is imprinted onto the sheet 120 during the manufacturing process, wherein the remainder of the design 122 can be colored as desired by a user via at least one drawing utensil 130. In a different embodiment, the sheet 120 has no design 122 imprinted during the manufacturing process, wherein a design 122 can be drawn on (and colored) by the user using the drawing utensil 130 prior to heat transfer. In a further embodiment, the design 122 may be fully imprinted and colored during manufacturing. These different embodiments allow a user to exercise various degrees of customization over the design 122 and/or color/appearance of the design 122.

The drawing utensil 130 may be any type of drawing utensil that is compatible with the transfer sheet 120. More specifically, this means that the drawing utensil 130 can be used to draw on the transfer sheet 120 prior to heat transfer, wherein any drawing left by the utensil 130 on the sheet 120 is transferred onto the board 110 surface using heat transfer. The utensil 130 may be any color. In one embodiment, the utensil 130 is a paint or a paint pen comprised of an acrylic paint or a fabric paint. In a different embodiment, the utensil 130 is comprised of a marker comprised of a permanent marker or a fabric marker.

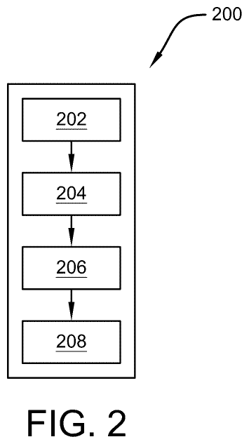

The present invention is also comprised of a method of using 200 the device 100, as seen in FIG. 2. First, a device 100 is provided comprised of a board 110, a transfer sheet 120, and a drawing utensil 130 [Step 202]. Then, a user can draw at least one design 122 on the transfer sheet 120 [Step 204]. Next, a user can place the transfer sheet 120 onto a surface of a board 110 and apply heat to the transfer sheet 120 for a period of time greater than at least 5 seconds [Step 206]. Finally, a user can remove the transfer sheet 120 from the board 110, wherein the design 122 is transferred onto a surface of the board 110 [Step 208].

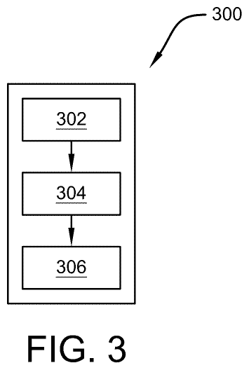

The present invention is also comprised of a method of using 300 the device 100, as seen in FIG. 3. First, a device 100 is provided comprised of a board 110, a transfer sheet 120 comprised of a design 122, and a drawing utensil 130 [Step 302]. Next, a user can place the transfer sheet 120 onto a surface of a board 110 and apply heat to the transfer sheet 120 for a period of time greater than at least 5 seconds [Step 304]. Finally, a user can remove the transfer sheet 120 from the board 110, wherein the design 122 is transferred onto a surface of the board 110 [Step 306].

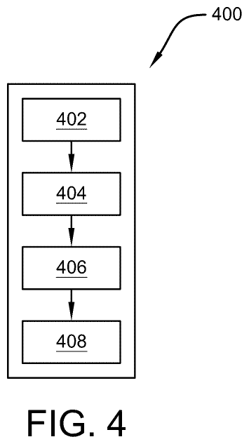

The present invention is also comprised of a method of using 400 the device 100, as seen in FIG. 4. First, a device 100 is provided comprised of a board 110, a transfer sheet 120 comprised of an outline of a design 122, and a drawing utensil 130 [Step 402]. Then, a user can color and/or fill in the outline of the design 122 using the drawing utensil 130 [Step 404]. Next, a user can place the transfer sheet 120 onto a surface of a board 110 and apply heat to the transfer sheet 120 for a period of time greater than at least 5 seconds [Step 406]. Finally, a user can remove the transfer sheet 120 from the board 110, wherein the design 122 is transferred onto a surface of the board 110 [Step 408].

In one embodiment, the sheet 120 may be comprised of a raised or recessed texture 124 to improve grip on the board 110. The texture 124 may be present on the sheet 120 and/or the design 122 such that it is transferred onto the board 110 to improve grip.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “heat-transfer board customization device” and “device” are interchangeable and refer to the heat-transfer board customization device 100 of the present invention.

Notwithstanding the forgoing, the heat-transfer board customization device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the heat-transfer board customization device 100 as shown in the FIGS. are for illustrative purposes only, and that many other sizes and shapes of the heat-transfer board customization device 100 are well within the scope of the present disclosure. Although the dimensions of the heat-transfer board customization device 100 are important design parameters for user convenience, the heat-transfer board customization device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A heat-transfer board customization device comprising:
a board; and
a heat-transfer transfer sheet.

2. The heat-transfer board customization device of claim 1, wherein the board is comprised of a skateboard, a snowboard, a surfboard, a paddleboard, or a wakeboard.

3. The heat-transfer board customization device of claim 1, wherein the heat-transfer transfer sheet is comprised of a heat transfer vinyl, a polyurethane transfer paper, a sublimation transfer paper, or a hot-peel transfer paper.

4. The heat-transfer board customization device of claim 1, wherein the heat-transfer transfer sheet is comprised of a design.

5. The heat-transfer board customization device of claim 4, wherein the design is comprised of a shape, a letter, a number, a picture, a scene, a logo, or a symbol.

6. A heat-transfer board customization device comprising:
a board;
a heat-transfer transfer sheet; and
a drawing utensil.

7. The heat-transfer board customization device of claim 6, wherein the board is comprised of a skateboard, a snowboard, a surfboard, a paddleboard, or a wakeboard.

8. The heat-transfer board customization device of claim 6, wherein the heat-transfer transfer sheet is comprised of a heat transfer vinyl, a polyurethane transfer paper, a sublimation transfer paper, or a hot-peel transfer paper.

9. The heat-transfer board customization device of claim 6, wherein the heat-transfer transfer sheet is comprised of a design.

10. The heat-transfer board customization device of claim 9, wherein the design is comprised of an indicia comprised of a shape, a letter, a number, a picture, a scene, a logo, or a symbol.

11. The heat-transfer board customization device of claim 10, wherein the indicia is comprised of an outline.

12. The heat-transfer board customization device of claim 6, wherein the drawing utensil is comprised of a paint pen.

13. The heat-transfer board customization device of claim 12, wherein the paint pen is comprised of an acrylic paint pen.

14. The heat-transfer board customization device of claim 12, wherein the paint pen is comprised of a fabric paint pen.

15. The heat-transfer board customization device of claim 6, wherein the drawing utensil is comprised of a marker.

16. The heat-transfer board customization device of claim 6, wherein the marker is comprised of a permanent marker.

17. The heat-transfer board customization device of claim 6, wherein the marker is comprised of a permanent marker.

18. The heat-transfer board customization device of claim 6, wherein the heat-transfer transfer sheet is comprised of a texture.

19. A method of using a heat-transfer board customization device, the method comprising the following steps:
providing a heat-transfer board customization device comprised of a board, a transfer sheet, and a drawing utensil;
drawing or coloring a design on the transfer sheet;
placing the transfer sheet onto a surface of the board;
applying heat to the transfer sheet; and
removing the transfer sheet from the board.

20. The method of using a heat-transfer board customization device of claim 19, wherein the transfer sheet is comprised of a heat transfer vinyl, a polyurethane transfer paper, a sublimation transfer paper, or a hot-peel transfer paper.
